(19) United States
(12) Patent Application Publication
(10) Pub. No.: US 2009/0291630 A1
(43) Pub. Date: Nov. 26, 2009

(54) GEOGRAPHIC TARGETING OF ALERTS

(76) Inventors: Timothy N. Dunn, Issaquah, WA (US); Simon Chapman, Issaquah, WA (US); Declan Farrell, Issaquah, WA (US)

Correspondence Address: PERKINS COIE LLP;PATENT-SEA, P.O. BOX 1247, SEATTLE, WA, 98111-1247, US

(21) Appl. No.: 12/253,886

(22) Filed: Oct. 17, 2008

Related U.S. Application Data
(60) Provisional application No. 61/037,316, filed on Mar. 17, 2008.

(51) Int. Cl. H04H 20/71; H04M 11/04

(52) U.S. Cl. 455/3.01; 455/404.1

(57) ABSTRACT

A system and method is described for broadcasting, e.g. commercial mobile alert messages (CMAM) or other messages including various text-based messages to a target area without substantially broadcasting to an area outside the target area. Further details and features are described herein.

### CROSS-REFERENCE TO RELATED APPLICATION

This application claims the benefit of the assignee's U.S. Provisional Patent Application No. 61/037,316, filed Mar. 17, 2008 (attorney docket number 14156/58).

### BACKGROUND

Mobile devices, such as wireless and cordless phones, handheld computers, smartphones, and media players, among others, have become ubiquitous. Most mobile devices, if not all, have messaging capabilities, such as text messaging via SMS (Short Message Service) and multimedia messaging via MMS (Multimedia Message Service). SMS and MMS have become popular modes of transmitting information to mobile device users. In addition, some fixed devices now share mobile device platforms and services. In particular, Unlicensed Mobile Access (UMA) devices, which may be fixed and replicate traditional “landline” operate on both cellular and IP-based networks.

In an emergency situation, such as a terror attack or a natural disaster (e.g., hurricane, tornado, and earthquake), it may be desirable to alert members of the public located in the particular area of the emergency such that they may have sufficient warning or receive instructions for responding to the emergency. Alternatively, it may be desirable to alert members of the public within a specific geographical area of a commercial offering that is available at a nearby retail location.

Federal Information Processing Standards codes (also known as FIPS Codes) are used by the US government to standardize the identification of different entities, such as states and counties. These codes are issued by the National Institute of Standards and Technology. The FIPS State Code is a two digit code used to identify the different states in the United States. Some two digit codes are used for the Emergency Alert System to identify regions or bodies or water. Each county in the United States also is assigned a FIPS code. The county FIPS code will start with the first two numbers in the state FIPS code, followed by three numbers unique to each county in the state. This combination creates a unique code for each county in the United States.

Currently, an emergency area is identified by a FIPS code or county. Thus, when an alert is sent in response to the emergency, the alert is sent to all mobile devices within the county (i.e., FIPS code area) that contains the emergency area. If, for example, the emergency or area affected by the emergency is located in portions of several different counties, an alert is sent to all mobile devices within all these counties. Hence, the current method for sending alerts to mobile devices involves the transmission of alerts to a substantial portion of the public that are not affected by the emergency. Such may result in unjustified panic among the public residing outside the emergency area. Over time, these erroneous alerts may cause the public to disregard alerts or warnings when they are actually relevant to the area they reside.

The need exists for a system that overcomes these problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIGS. 1A and 1B show a system level schematic illustration of an alert system operable to implement aspects of the invention. Hereinafter, FIGS. 1A and 1B will collectively be referred to as FIG. 1.

FIG. 2 is a flow diagram of a method for targeted broadcasting.

FIG. 3 is geographical illustration of the method of FIG. 2.

The headings provided herein are for convenience only and do not necessarily affect the scope or meaning of the claimed invention.

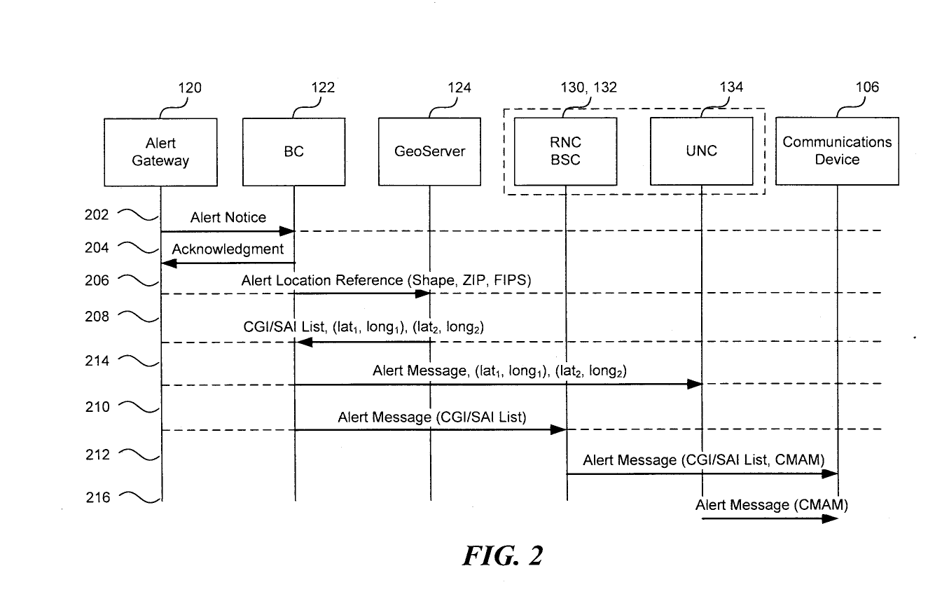

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 202 is first introduced and discussed with respect to FIG. 2).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention incorporates many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

### System Description

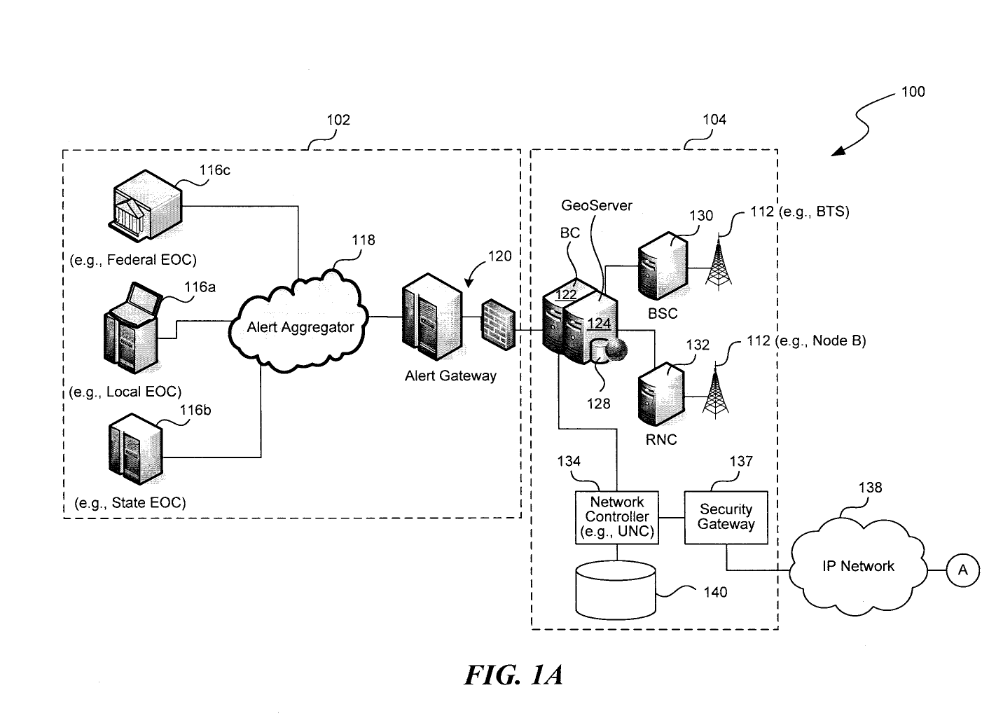

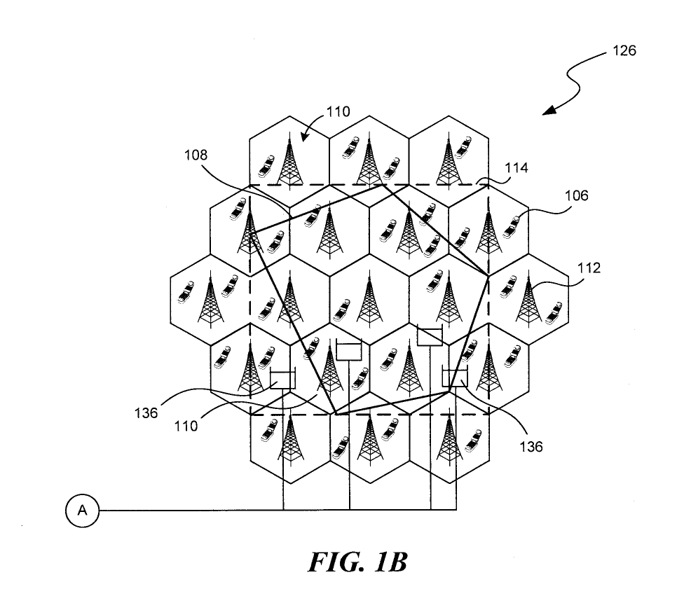

FIG. 1 and the following discussion provide a brief, general description of a suitable environment in which the invention can be implemented. Although not required, aspects of the invention are described below in the general context of computer-executable instructions, such as routines executed by a general-purpose data processing device, e.g., a networked server computer, mobile device, or personal computer. Those skilled in the relevant art will appreciate that the invention can be practiced with other communications, data processing, or computer system configurations, including: Internet appliances, hand-held devices (including personal digital assistants (PDAs)), wearable computers, all manner of corded, landline, fixed line, cordless, cellular or mobile phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While aspects of the invention, such as certain functions, are described as being performed exclusively or primarily on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

FIG. 1 shows a system level schematic illustration of an alert system, in this case a Commercial Mobile Alert System (CMAS) 100. The alert system 100 comprises an alerting network 102 coupled to a broadcasting network 104 operable to transmit targeted broadcasting. The alerting network 102 is operable to create an alert message and send it to the broadcasting network 104 for transmitting to devices 106 positioned in a target area 108. The devices 106 may be any of a variety of fixed or mobile devices, such as wired, wireless and cordless phones, Unlicensed Mobile Access or UMA enabled devices, handheld computers, smartphones, media players, and the like that are enabled for use within at least the target area 108. The UMA enabled devices may, for example, be landline devices and may take the form of RJ-11-type devices (or similar devices), such as telephones that plug into an RJ-11 (or similar) port on a UMA access point.

The target area 108 may include one or more landline networks, cellular networks or IP-based networks. A cellular network is a radio network made up of a number of cells 110 each served by a fixed transmitter known as a base station 112. (Base stations 112 of FIG. 1A are shown in a cellular broadcasting system 126 in FIG. 1B.) These cells 110 are used to cover different contiguous and/or overlapping geographical broadcast areas in order to provide radio coverage over a wider area than the area of a single cell 110. Cellular networks may additionally incorporate picocells, which are smaller base stations typically with shorter wireless range and incorporated into residential or business premises to provide local coverage to the residence or business. Picocells may be directly connected to the cellular network and therefore appear on the telecommunications network as base stations with their own Cell Global Identity (CGI) values.

An IP-based network is any IP-based telecommunications network, including both wired and wireless networks. For instance, a Voice Over Internet Protocol (VoIP) network is any wired or wireless network in which voice communications are “packetized” for transmission over the Internet. UMA networks and femtocell networks are similar to VoIP networks, in that voice communications are packetized and transmitted over the Internet. UMA networks typically feature WiFi access points for receiving and sending voice communications over unlicensed spectrum; femtocell networks typically feature wireless access points broadcasting within licensed spectrum of a telecommunications service provider, with conversion of voice communications into IP packets for transmission over the Internet.

The alert message may, for example, be implemented using any messaging protocol, such as SMS (Short Message Service), MMS (Multimedia Messaging Service), electronic mail (email), IM (instant message), Morse code and/or voice message. The alert message may be a warning to alert the public of emergencies such as a disaster (e.g., terrorist attack), imminent or on-going threats (e.g., hurricane, tornado, earthquakes), and/or child abductions (e.g., Amber Alerts). The alert message may also include various instructions for responding to the emergency. In other embodiments, the alert message may take the form of an advertisement, survey or the like. The advertisement or survey may, for example, target people located in a particular geographic region.

The alerting network 102 may send a target area signal, which includes geographical location information corresponding to the target area 108, to the broadcasting network 104. Alternatively, the alerting network 102 may embed the geographical location information in the alert message. The geographical location information may include place name information such as, for example, Potomac River Valley or the like. In other embodiments, the geographical location information may take the form of a FIPS code, ZIP code, or GPS coordinates. The broadcasting network 104 determines one or more identifiers (e.g., a Cell Global Identity identifier or CGI) associated with one or more base stations 112 and/or cells 110 at least partially located within the target area 108. In cellular network embodiments, the identifier comprises a cell identity, which may be a 16 bit identifier combined with a Location Area Identity (LAI) or Routing Area Identity (RAI). The identifier uniquely identifies a respective base station 112 and/or cell 110. As discussed in detail below, the identifier can, in IP-based networks, identify base stations 112 and/or access points 136 serving the target area 108 or an adjusted target area 114 (described in detail below). For instance, in IP-based embodiments, the identifiers may be IP addresses, MAC addresses or other identifiers associated with access points 136 located within the target area 108. Based on the identifier(s), the broadcasting network 104 can send the alert message via these base stations 112 and/or access points 136 to the devices 106 in the target area 108.

Alternatively or additionally, as described in detail below, the broadcasting network 104 may calculate a shape (e.g., polygon) from the geographical location information (e.g., FIPS, ZIP, or GPS coordinates) included in the target area signal that represents the target area 108. In some embodiments, the geographic location information may already be in the form of a shape (e.g., 5 mile radius with a center at a defined coordinate or a base station, or a polygon) that represents the target area 108. The broadcasting network 104 determines an adjusted target area 114 that substantially estimates the target area 108. In other words, the adjusted target area 114 or second area may enclose the target area 108 or first area, and thus the adjusted target area 114 or the second area may overlap the target area 108 or the first area. The broadcasting network 104 may then forward the alert message to base stations 112 and/or access points 136 for broadcasting to the devices 106 that are located within the adjusted target area 114 without substantially broadcasting to devices 106 outside the adjusted target area 114.

The alerting network 102 may comprise one or more alerting entities 116a, 116b, 116c (collectively referenced as 116). In this case, the alerting network 102 comprises a government alerting network 102 that includes one or more government entities. The entities 116 may, for example, represent one or more local, state, and federal agencies having one or more EOCs (Emergency Operation Center), respectively. Alternatively, the entities may represent one or more commercial entities, marketing firms or similar entities engaged in developing and broadcasting commercial alerts. Each entity can create a respective alert message to be sent to the broadcasting network 104. The alert message may be in CAP (Common Alerting Protocol) format. The CAP is an XML-based data format for exchanging public warnings and emergencies between alerting technologies. CAP allows a warning message to be consistently disseminated simultaneously over many warning systems to many applications.

The alerting network 102 may include an alert aggregator 118 to determine the alert message to be sent to the broadcasting network 104 based on the respective alert messages created by the entities (EOCs). The alert aggregator 118 may, for example, allocate a priority to each entity and choose to forward the alert message received from that entity having the highest priority. Alternatively, the alert aggregator 118 may send the respective alert messages as successive alert messages or as a single alert message. Those skilled in the art will recognize that the alert aggregator 118 may be programmed in several different ways to create or determine the alert message to be sent to the broadcasting network 104.

The alert network further comprises an alert gateway 120 which receives the alert message (e.g., alert message in CAP format) from the alert aggregator 118 and converts the alert message into a format supported by the broadcasting network 104 (e.g., text profile base CMAM (Commercial Mobile Alert Message) format). The alert gateway 120 sends the converted alert message, hereinafter CMAM, to the broadcasting network 104.

The broadcasting network 104 comprises a broadcast center (BC) 122, a geoserver 124, and a cell broadcasting system 126. The BC 122 receives the CMAM from the alert gateway 120 which may include the geographic location information of the target area 108 embedded in the CMAM. Alternatively, according to one embodiment, the BC 122 may receive the target area signal from the alerting network 102 that provides the geographic location information of the target area 108. In such embodiment, the target area signal is sent in addition to the CMAM (i.e., alert message). This target area signal having the geographic location information may also be converted into text profile based CMAM format. The BC 122 may run a validation test on the CMAM and send an error response to the alerting network 102 if the CMAM fails validation. Such may result in the CMAM not being broadcast.

The geoserver 124 receives the geographic location information of the target area 108 from the BC 122. Although FIG. 1 illustrates the geoserver 124 as a separate component from the BC 122, in some embodiments the geoserver 124 may be embedded within the BC 122, such as operating on the same server. The geographic location information may, for example, be in the form of FIPS, ZIP, GPS coordinates, or a defined shape. If the geographical location information is received in the form of FIPS, ZIP, or GPS coordinates, the geoserver 124 transforms the geographic location information into the shape (e.g., a polygon) representing the target area 108. Otherwise, the geographic location information received from the BC 122 is already in a form of the shape representative of the target area 108. The transformation into the representative shape (e.g., a polygon) of the target area 108 may occur in real-time to provide a more accurate alert and respond to daily changes. The daily changes may be in the form of changes in the boundaries of the target area 108 in response to changes in the emergency conditions. For example, path changes of a hurricane or twister, wind shifts during forest fires, or updated intelligence on an imminent terror attack may reflect a change in the boundaries of the target area 108. In some embodiments, the alerting network 102 provides the BC 122 with external data, e.g., meteorological data and/or updated intelligence data, to show changes in hurricane or twister path or other natural disaster, and/or changes to a potential terror area. The external data can be used by components of the broadcasting network 104 to alter the boundaries of the target area 108 in real-time.

The geoserver 124 has access to one or more databases 128 including identification and location and/or geographical coverage information for base stations 112, cells 110 served by base stations 112, access points 136 and/or areas served by access points 136. Although FIG. 1 illustrates the database(s) 128 as separate from, but directly connected with, geoserver 124, in some embodiments one or more databases may be distributed anywhere in the broadcasting network 104. For example, geoserver 124 may be capable of accessing database 140, which may be associated with a VoIP or UMA/GAN network of broadcasting network 104 and situated geographically remote from geoserver 124. In a cellular broadcasting network, database(s) 128 may store CGI information for respective cells 110 that are included in the target area 108, as well as cell 110 coverage area information. Similarly, in a VoIP or UMA/GAN network, the database(s) 128 and/or 140 may be stored with IP addresses, MAC addresses or other identifiers for respective access points 136 that are included in the target area 108.

In an embodiment, the geoserver 124 implements a point-in-polygon search to determine the identifiers (e.g., CGI, IP addresses, MAC addresses and other relevant identifiers) for base stations 112 and/or access points 136 that are situated within the target area 108. This can be done by, e.g., determining the latitude and longitude extent of the target area 108 (e.g., polygon), identifying those base stations 112 and/or access points 136 that are situated within the target area 108, and obtaining the identifiers associated with such base stations 112 and/or access points 136. Alternatively or additionally, the geoserver 124 may determine the latitude and longitude extent of the target area 108 (e.g., polygon), determine whether all or any portion of the cells 110, base stations 112, access points 136 (e.g., using point-in-polygon search), or coverage areas (e.g., using polygon-in-polygon search) extend into an area outside the target area 108, and obtain identifiers associated with those base stations 112 and/or access points 136. Details on techniques for implementing the point-in-polygon search may, for example, be found in an article by Bourke, Paul, entitled “Determining If A Point Lies On The Interior Of A Polygon,” November 1987, and in U.S. Pat. No. 5,124,693. The polygon-in-polygon search technique may, for example, be found in U.S. Pat. No. 5,124,693. The obtained base station 112 and/or access point 136 information may include, in addition to relevant identifiers, location coordinates such as coverage areas of the cells 110, and/or latitude and longitude of the base stations 112, access points 136 and/or UMA devices (e.g., RJ-11 telephones), similar to the CGI information provided for 911 services in a location center, such as a gateway mobile location center (GMLC). In some embodiments, the location coordinates of the UMA devices may be stored in the GMLC. The geoserver 124 forwards a list of the determined identifiers (e.g., CGI, IP addresses, MAC addresses and/or other identifiers) to the BC 122.

Alternatively or additionally, the geoserver 124 may determine the adjusted target area 114 (e.g., rectangle, square, or circle) 114 that substantially estimates the representative shape of the target area 108 using one of any known best-fit algorithms. For example, the geoserver 124 may define a center of the target area 108 and a radius defining the adjusted target area 114 (i.e., circle) that forms a best-fit circle encircling or just within the target area 108. Alternatively, the adjusted target area 114 may be a “best-fit” rectangle that fits around or within the boundary of the target area 108. Some best-fit algorithms may include a determination of first and second best-fit areas, and if the first best-fit area minus the target area 108 is greater than the second best-fit area minus the target area 108, the algorithm selects the second best-fit area as the adjusted target area 114.

The geoserver 124 may calculate location coordinates (e.g., latitude and longitude) of opposite corners of the adjusted target area 114. Alternatively, the geoserver 124 may calculate a location coordinate of the center of the adjusted target area 114 and the radius, which define the adjusted target area 114. Although reference will herein be made to the opposite corners defining the adjusted target area 114, it will be understood by those skilled in the art that defining the adjusted target area 114 by determining various other coordinates such as the center coordinate and the associated radius is also within the scope of aspects of the invention. The location coordinates of the opposite corners may be forwarded to the BC 122 for validation. The geoserver 124 then, or coincidentally with the calculation of the adjusted target area 114, obtains identifiers as described above.

Alternatively or additionally, the geoserver 124 may adjust the boundaries of the “best fit” adjusted target area to accommodate or ensure maximum broadcast coverage in the target area 108, using a “best coverage” algorithm. For example, a “best fit” adjusted target area 114 may include all base stations 112 and/or access points 136 within its borders, but may not capture all of the relevant coverage area within the adjusted target area 114 because some percentage of coverage within the adjusted target area 114 is provided by base stations 112 and/or access points 138 located outside the adjusted target area 114. For example, a base station 112 may be located outside of the adjusted target area 114, but its associated cell 110 coverage area may intersect with a portion of the adjusted target area 114. In those cases, a “best coverage” algorithm may be executed to extend the outward borders of the adjusted target area 114 to ensure that the broadcast alert is broadcast from sufficient base stations 112 and/or access points 136 to ensure maximum coverage of the adjusted target area 114. The location coordinates of the opposite corners of the adjusted target area 114 may be forwarded to the BC 122 for validation.

As illustrated in FIG. 1, the broadcasting network 104 may include a cellular broadcasting network. The cellular broadcasting network may, for example, take a form of a GSM or UMTS broadcast architecture, or a combination thereof. Those skilled in the art will understand that GSM and/or UMTS are typical of all cellular network architectures. As is known in the telecommunications industry, GSM network architecture includes one or more Base Station Controllers (BSCs) 130 that control one or more base stations or Base Transceiver Stations (BTSs). In this case, the BTSs may be the base stations 112 that serve the one or more cells 110 within the target area 108. The UMTS network architecture includes at least a Radio Network Controller (RNC) 132 which provides control functionality of the base stations (i.e., Node B's) 112. In this case, the Node B's may be the base stations 112 that serve the cells 110 located within the target area 108. Both the BTSs and the Node B's are communicatively coupled to the devices 106 within the target area 108.

In some embodiments, a picocell may be communicatively coupled to a base station in a cellular network. The picocell is a wireless access point typically covering a relatively small area, such as within a building (e.g., office, shopping mall, train station, or the like) or within an aircraft, ship, train or other vehicle. A picocell may, for example, be analogous to a WiFi access point, except that it typically broadcasts using the licensed spectrum of an associated wireless carrier. The picocell serves as an access point for routing communication between the device 106 and the access point. One or more picocells may be coupled to the BSC by way of wired or wireless connection. Picocells appear as base stations on cellular networks and, therefore, will have CGI identifiers associated with them. It will be appreciated by those skilled in the relevant art that picocell implementations of the invention are within the scope of aspects of the invention disclosed herein.

The BSCs 130 and/or the RNCs 132 of the broadcasting network 104 (i.e., cellular network) receive the CMAM (converted alert message) from the BC 122 and the list of identifiers (e.g. CGIs) for purposes of generating an alert broadcast. The identifier listings may be included in the CMAM or may be sent in a separate message. For example, the geoserver 124 has access to the database 128 which includes the geographic locations of the base stations 112 and/or geographic coverage areas of the cells 110 served by the base stations 112, along with the identifiers (e.g., CGIs) associated with the base stations 112. Based on a look-up of the database 128, the geoserver 124 can identify identifiers (e.g. CGIs) for those base stations 112 located within the target area 108 and/or the cells 110 that wholly or partially intersect target area 108. The geoserver 124 sends a list of the identifiers to the BC 122 for forwarding to the BSCs 130 and/or the RNCs 132. The BSCs 130 and/or the RNCs 132 can then broadcast the CMAM via the identified base stations 112 to the devices 106 located within the target area 108 without substantially broadcasting to devices 106 located outside the target area 108.

For cells 110 that straddle a boundary, the cell 110 may avoid transmitting to devices 106 outside the boundary by using smarter antennas (e.g., directional antennas) and not transmitting on sectors outside the boundary. Directional antennas are configured to radiate greater power in one or more directions allowing for increased performance on transmit and receive, and reduced interference from unwanted sources. Directional antennas may provide increased performance over dipole antennas when a greater concentration of radiation in a particular direction or region is desired.

In some embodiments, the cells 110 may be sub-divided into sectors, each of which comprises an antenna (e.g., directional antenna) operable to broadcast to a respective one of the sectors. Thus, for the cells 110 that straddle the target area 108 boundary, the sectors located within the target area 108 will transmit the CMAM, while sectors outside the target area 108 will not.

For overlapping cells 110, that is, two or more cells 110 which overlap at least a portion of a same region, the CMAM may be sent to individual subscribers within the overlapping region. Such may advantageously avoid duplicate CMAMs being sent to a single subscriber when that subscriber is located in the overlapping region being serviced by the overlapping cells 110. In some embodiments, the BSCs and/or the RNCs 112 may be configured to determine the subscribers located in the overlapping region and broadcast the CMAM to those subscribers, while in other embodiments a master base station controller (e.g., MSC) may determine the subscribers located in the overlapping regions and control the BSCs and/or the RNCs 112 to broadcast the CMAM to those subscribers.

Alternatively and/or additionally, the broadcasting network 104 may, for example, include IP-based broadcast architectures, such as a VoIP broadcast architecture, UMA or GAN (Generic Access Network) broadcast architecture, or a femtocell broadcast architecture. Voice Over Internet Protocol, or VoIP, is a telecommunication system for the transmission of voice over the Internet or other packet-switched networks. Unlicensed Mobile Access or UMA, is the commercial name of the 3GPP Generic Access Network or GAN standard. Somewhat like VoIP, UMA/GAN is a telecommunication system which extends services, voice, data, and IP Multimedia Subsystem/Session Initiation Protocol (IMS/SIP) applications over IP-based networks. For example, a common application of UMA/GAN is in a dual-mode handset service in which device users can seamlessly roam and handover between local area networks and wide area networks using a GSM/Wi-Fi dual-mode mobile phone. UMA/GAN enables the convergence of mobile, fixed and Internet telephony, sometimes called Fixed Mobile Convergence. Femtocells are much like picocells, broadcasting within the licensed spectrum of a wireless telecommunications carrier. Femtocells are typically designed for use in residential or small business environments. Femtocells connect to the service provider's network much like UMA/GAN access points, namely over IP-based networks.

VoIP, UMA/GAN and femtocell architectures include a network controller (e.g., a UNC in a UMA/GAN embodiment)) 134 that passes voice and data signals between the device (e.g., a UMA/GAN device) 106 and the BC 122. The network controller 134 receives/sends packets from/to the device 106 (e.g., UMA device) via an access point (e.g., a wired access point, a wireless access point with WiFi, a femtocell with wireless capability) and over an IP network 138. A security gateway 137 may be incorporated in order to establish a secure IP connection between the access point and the network controller 134.

The access points 136 are registered as part of the relevant network. Geographic location information associated with access points 136 are known to the network controller 134 and geoserver 124. For example, the network controller 134 and geoserver 124 may have access to a database 140 of registered access points 136 and their associated location information. The location information can be geographic coordinates (e.g., latitude and longitude) of the access point 136 used to route communication between the device 106 and the network controller 134. Alternatively, the location information can be the geographic coordinates of the device itself, such as a street address, which may need to be converted into latitude and longitude coordinates. For example, when an access point is initially registered with the network under a UMA system, the user may be required to input a street address for the location of the access point, where the system may then obtain and store in a database the latitude and longitude coordinates for the access point. Details on techniques for locating access points may be found in PCT App. No. PCT/US07/82156, System And Method For Determining A Subscriber's Zone Information, Oct. 22, 2007, (31419.8034.WO); PCT App. No. PCT/US07/82133, Two Stage Mobile Device Geographic Location Determination, Oct. 22, 2007, (31419.8035.WO); PCT App. No. PCT/US07/82136, System And Method For Utilizing IP-Based Wireless Telecommunications Client Location Data, Oct. 22, 2007, (31419.8036.WO); U.S. patent application Ser. No. 12/089,905, System And Method For Determining Device Location In An IP-Based Wireless Telecommunications Network, Apr. 10, 2008, (31419.8028.US1); and PCT App. No. PCT/US07/66579, Mobile Computing Device Geographic Location Determination, Apr. 12, 2007, (31419.8030.WO).

The IP-based system receives the CMAM (i.e., converted alert message) and the location coordinates of the opposite corners of the rectangular shape 114 from the BC 122. The network controller 134 performs a lookup of the UMA registered devices in the database 140 to identify those devices that are within the rectangular shape 114. In other words, the network controller 134 compares the coordinates associated with the registered devices to the location coordinates of the opposite corners of the rectangular shape 114, to select those registered devices that are within the adjusted target area 114 for broadcasting. Based on such determination, the UMA/GAN networks broadcasts the CMAM to the devices that are within the adjusted target area 114 without substantially broadcasting the CMAM to devices located outside the adjusted target area 114.

In general, the processes described herein are equally applicable to cellular networks, IP-based telecommunications networks and other networks or communication systems, such as UMA/GAN, femtocells, picocells, etc., and thus detailed descriptions of those systems are unnecessary. In some UMA/GAN embodiments, the network controller 134 may be configured to perform some or all of the functions of BC 122 and/or geoserver 124. While the database 140 is shown separately from the database 128, a single database may be employed; so too, more than two distributed databases may be employed.

### Example Process/Call Flow

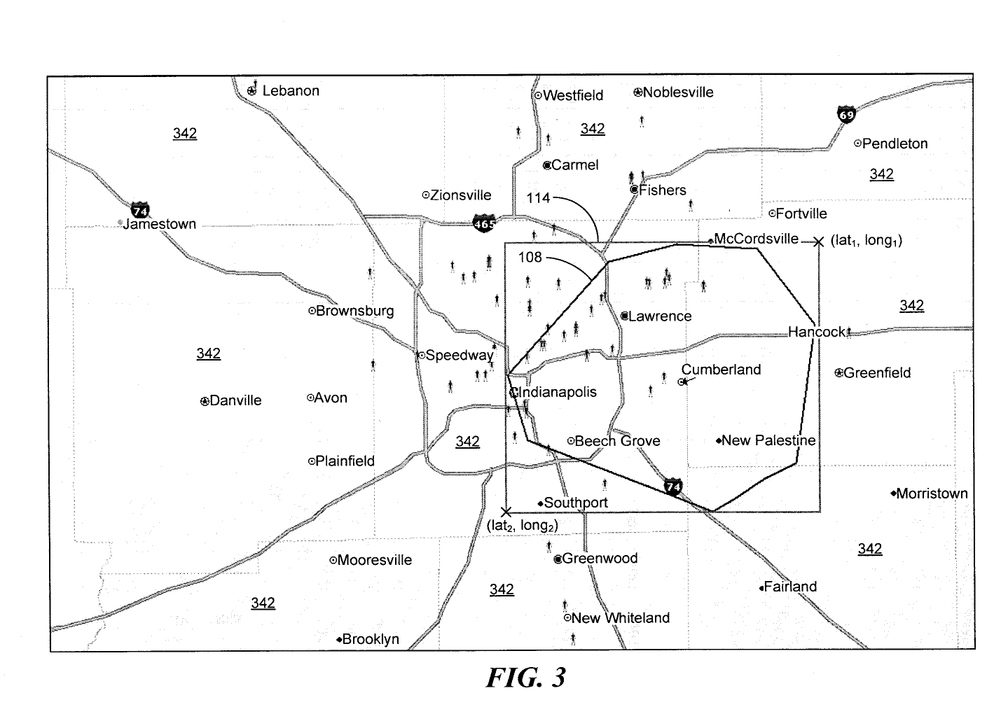

FIG. 2 shows a flow diagram of a method for targeted broadcasting, as described above, while FIG. 3 shows a geographical illustration of the method of FIG. 2. As discussed above, the alert gateway 120 converts the alert message (e.g., alert message in CAP format) into a format supported by the broadcasting network 104 (e.g., text profile base CMAM).

At 202, the alert gateway 120 sends the CMAM to the BC 122. The BC 122 receives the valid CMAM from the alert gateway 120 including the geographical location information (hereinafter “GLI”) of the target area 108.

At 204, the BC 122 sends an acknowledgment to the alert gateway 120 notifying the alerting network 102 that a valid CMAM was received.

At 206, the BC 122 transmits the GLI and queries the geoserver 124 to determine the specific cells 110 within the target area 108 to be used for target broadcasting. Alternatively or additionally, the BC 122 queries the geoserver 124 to obtain the shape (e.g., geographic shape) that represents the target area 108 for target broadcasting. The representative shape may, for example, take a form of a polygon, square, rectangle, circle or any shape that sufficiently represents the target area 108, as noted above. Both the determination of the one or more cells 110 within the target area 108 and the representative shape are based on the received GLI. The GLI may, for example, be selected from a Geographic Names Information System (GNIS). The GNIS is a database that includes name and locative information regarding physical and cultural features located throughout the United States of America and its territories. The GNIS is part of a system that includes topographic map names and bibliographic references. Alternatively or additionally, the GLI of the target area 108 may be received in terms of a particular code, such as FIPS (Federal Information Processing Standards) or ZIP code. FIPS codes are used by the US government to standardize the identification of different entities, such as states and counties. These codes are issued by the National Institute of Standards and Technology. For example, each county in the United States is assigned a FIPS code. ZIP codes on the other hand designate quadrants or locations within a county.

The geoserver 124 transforms the GLI (e.g., GNIS, FIPS code, ZIP code, or GPS coordinates) into the shape that represents the target area 108. The representative shape may be an approximate geographical representation that best estimates the target area 108. The geoserver 124 may have access to one or more processors operable to approximate the representative shape of the target area 108 based on the GLI. Alternatively, the GLI is received in terms of the representative shape (e.g., 5 mile radius having a center at a defined coordinate).

FIG. 3 shows a geographical illustration of several counties 342 having devices 106 located throughout. As illustrated in FIG. 3, the target area 108 includes portions of three of these counties 342. In contrast, a representation of the target area 108 by FIPS code alone would define the target area 108 as encompassing the entire three counties 342, instead of only the select portions of these three counties 342. Such would unnecessarily alert device 106 users outside the intended target area 108.

For target broadcasting via the broadcasting system 126, at 208 the geoserver 124 accesses the database 128 (not shown in FIG. 2) to identify the identifiers of respective cells 110 located within the target area 108. The geoserver 124 may perform a point-in-polygon search, polygon-in-polygon search or similar search to identify the identifiers within the target area 108. The geoserver 124 creates a list of identifiers of respective cells 110 and/or base stations 112 located in the target area 108 for forwarding to the BC 122.

Additionally or alternatively, for target broadcasting via the broadcasting system 126, the geoserver 124 calculates the adjusted target area 114 (illustrated in FIG. 3) that substantially approximates the target area 108. The adjusted target area 114 approximation of the target area 108 allows for a two-point determination of the adjusted target area 114. For example, as illustrated in FIG. 3, two opposite points of the adjusted target area 114 may define a rectangular shape. The two points may comprise a first latitude/longitude coordinate (lat₁, long₁) and a second latitude/longitude coordinate (lat₂, long₂). The boundary of the adjusted target area 114 is thus readily defined by an area between the first and second latitudes, and between the first and second longitudes. The geoserver 124 determines these two opposite points (lat₁, long₁), (lat₂, long₂) for forwarding to the BC 122.

It will be appreciated by those skilled in the art that other methods for defining the adjusted target area 114 are within the scope of the invention describe herein. For example, the adjusted target area 114 may be a circle defined by two values: a center coordinate and a radius.

Upon determining the list of identifiers (i.e., CGIs) of the respective cells 110 and/or the base stations 112 within the target area 108 and/or the two opposite points (lat₁, long₁), (lat₂, long₂) of the adjusted target area 114, the geoserver 124 forwards the list of CGIs of the respective cells 110 and/or the base stations 112 in the target area 108 and/or the coordinates of the opposite points of the adjusted target area 114 to the BC 122. For the GSM/UMTS system, the BC 122, at 210, sends the CMAM to the BSCs 130 and/or RNCs 132 that serve the cells 110 and/or base stations 112 identified in the CGI list. At 212, the BSCs 130 and the RNCs 132 can then transmit to the base stations 112 serving enabled devices 106 in the target area 108 without substantially broadcasting outside the target area 108.

For the UMA/GAN system, the BC 122, at 214, sends the CMAM and the two coordinates of the opposite points on the adjusted target area 114 to the network controller 134, such as a UMA Network Controller (UNC). The CMAM and the two coordinates may be forwarded in consecutive alert messages or embedded in a single alert message. The UNC 134 performs a point-to-polygon lookup of the coordinates of the registered UMA devices with the UMA network. The UNC 134 compares the coordinates associated with the registered UMA devices to coordinates falling within the geographic dimensions of the constructed adjusted target area 114 (i.e., the rectangular shape constructed from the two coordinates of the opposite rectangle corners or a circle constructed from the center coordinate and associated radius) to determine those UMA devices having registered location information within the adjusted target area 114. As discussed above, the location information of the UMA devices may be the geographic coordinates of the access points 136. In some embodiments, the location information of the UMA devices may take the form of street addresses associated with the access points 136 that are converted to the geographic coordinates.

At 216, upon identifying the UMA devices located within the adjusted target area 114, the UNC 134 can then broadcast the CMAM to those UMA devices that are located within the adjusted target area 114 without substantially broadcasting outside the adjusted target area 114.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while aspects of the invention are described above with respect to capturing and routing digital images, any other digital content may likewise be managed or handled by the system provided herein, including video files, audio files, and so forth. While processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times.

The teachings of the invention provided herein can be applied to other systems, not necessarily the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A system for providing alerts to mobile telecommunications devices within a wireless network, the system comprising:
means for receiving an indication of a public service message to be broadcast to multiple mobile telecommunications devices within a first geographic region;
means for determining one or more cells or wireless broadcast regions at least partially positioned within the first geographic region;
means for identifying one or more broadcasting stations that respectively serve the one or more cells or wireless broadcast regions; and
means for sending the public service message to the identified one or more broadcasting stations for broadcasting to the multiple mobile telecommunications devices within a first geographic region without substantially broadcasting to mobile telecommunications devices outside the first geographic region.

2. The system of claim 1, further comprising:
means for defining a second geographic region based on the indication of the public service message to be broadcast to multiple mobile telecommunications devices,
wherein the second geographic region approximates the first geographic region;
means for identifying a first set of multiple mobile telecommunications devices within the second geographic region; and
means for forwarding the public service message to the first set of multiple mobile telecommunications devices within the second geographic region, and not to a second set of multiple mobile telecommunications devices outside of the second geographic region.

3. The system of claim 2 wherein the public service message is a short messaging service (SMS) message, electronic mail message, MMS (Multimedia Messaging Service), or an instant message (IM).

4. The system of claim 1 wherein the public service message is a text-based message format.

5. The system of claim 1 wherein the means for receiving receives the indication from a local, state, or federal agency, and wherein the indication includes at least one code that defines at least the first geographic region.

6. The system of claim 2 wherein the first and second geographic regions are substantially equivalent.

7. The system of claim 2 wherein the means for defining includes means for defining a regular polygon for the second geographic region, wherein the regular polygon approximates the first geographic region.

8. The system of claim 2 wherein the means for defining includes means for defining a rectangle for the second geographic region, wherein the rectangle approximates the first geographic region.

9. The system of claim 2 wherein the means for identifying employs a point within polygon or polygon within polygon process to identify cell sites within the second geographic region.

10. The system of claim 2 wherein the means for identifying includes means for querying a database for latitude and longitude coordinates associated with street addresses for wireless equipment associated with a first set of multiple mobile telecommunications devices, wherein the wireless equipment includes a picocell, a femtocell, or an IEEE 802.11 access point.

11. The system of claim 2 wherein the means for forwarding the public service message includes providing public safety instructions or direction to each of the first set of multiple mobile telecommunications devices within the second geographic region, and wherein the public service message is assigned one of multiple priority levels.

12. The system of claim 1 wherein the means for identifying includes determining if latitude and longitude coordinates of base stations or cell sites lie within latitude and longitude coordinates of a boundary defining the second geographic region.

13. A computer-readable medium storing instructions for a computer within a wireless network to assist in broadcasting messages to mobile telecommunications devices, the method comprising:
receiving an indication of a message to be broadcast to multiple mobile telecommunications devices within a first geographic region or regions;
defining at least a second geographic region based on the indication of the message to be broadcast to the multiple mobile telecommunications devices,
wherein the second geographic region approximates the first geographic region or regions;
identifying, within the second geographic region, a first set of wireless transmitter or transceiver devices associated with the wireless network; and
forwarding a selected message to the first set of wireless transmitter or transceiver devices associated with the wireless network, and not forwarding the selected message to a second set of wireless transmitter or transceiver devices outside of the second geographic region,
wherein both the first and second sets of wireless transmitter or transceiver devices provide telecommunications services associated with the wireless network,
wherein the message is not an advertisement or a commercial offer, and
wherein the selected message is substantially concurrently transmitted to the first set of wireless transmitter or transceiver devices within the second geographic region.

14. The computer-readable medium of claim 13 wherein the selected message is a short messaging service (SMS) message, a multimedia messaging service (MMS), an electronic mail message, an instant message (IM), or a prerecorded voice message.

15. The computer-readable medium of claim 13 wherein the receiving includes receiving the indication from a local, state, or federal agency, and wherein the indication includes at least one code that defines at least the first geographic region.

16. The computer-readable medium of claim 13 wherein the first and second geographic regions are substantially equivalent.

17. The computer-readable medium of claim 13 wherein the defining includes defining a regular polygon for the second geographic region, wherein the regular polygon approximates the first geographic region.

18. The computer-readable medium of claim 13 wherein the defining includes defining a rectangle for the second geographic region, wherein the rectangle approximates the first geographic region.

19. The computer-readable medium of claim 13 wherein the identifying includes employing a point within polygon or polygon within polygon process to identify cell sites within the second geographic region.

20. The computer-readable medium of claim 13 wherein the identifying includes querying a database for latitude and longitude coordinates associated with street addresses for private wireless equipment associated with the first set of wireless transmitter or transceiver devices, and wherein the private wireless equipment includes a femtocell, a picocell, or a WiFi access point.

21. The computer-readable medium of claim 13 wherein the forwarding includes providing public safety instructions or directions to each of the first set of wireless transmitter or transceiver devices within the second geographic region, and wherein the selected message is assigned one of multiple priority levels.

22. The computer-readable medium of claim 13 wherein the identifying includes determining if latitude and longitude coordinates of wireless base stations or cell sites lie within latitude and longitude coordinates of a boundary defining the second geographic region.

23. The computer-readable medium of claim 13 wherein the forwarding includes forwarding the selected message over UMA/GAN network to at least some of the first set of wireless transmitter or transceiver devices.

24. The computer-readable medium of claim 13 wherein the forwarding includes forwarding the selected message over an IP-based network to at least some of the first set of wireless transmitter or transceiver devices in the second geographic region.

25. The computer-readable medium of claim 13 wherein the identifying includes determining coordinates or locations of private wireless equipment within the second geographic region, and wherein the private wireless equipment includes a femtocell, a picocell, or a WiFi access point.

26. The computer-readable medium of claim 13 wherein the stored instructions for the computer within the wireless network assist in broadcasting messages to landline phones within the second geographic region.

27. The computer-readable medium of claim 13, further comprising:
determining one or more cells or wireless broadcast regions at least partially positioned within the first geographic region or regions;
identifying one or more broadcasting stations that respectively serve the one or more cells or wireless broadcast regions; and
sending the selected message to the identified one or more broadcasting stations for broadcasting to a first set of mobile telecommunications devices within the first geographic region or regions without substantially broadcasting to mobile telecommunications devices outside the first geographic region.

28. A method for broadcasting a message to a target area, the method comprising:
receiving a message to be broadcast to a first area and not to be substantially broadcast to a second area adjacent the first area;
if location information of one or more broadcasting stations is known:
determining one or more cells or wireless broadcast regions at least partially positioned within the first area,
identifying the one or more broadcasting stations that respectively serve the one or more cells or wireless broadcast regions, and
sending the message to the identified broadcasting stations for broadcasting to devices enabled to communicate with the identified broadcasting stations; and
if location information associated with registered devices is known:
defining a geographic area that approximates the first area without encompassing substantial portions of the second area;
determining the registered devices that are positioned within the defined geographic area, and
broadcasting the message to the registered devices positioned within the defined geographic area.

29. The method of claim 28 wherein identifying the one or more broadcasting stations that respectively serve the one or more cells comprises accessing a database stored with CGI (Cell Global Identity) information of cells within the first and second areas and identifying the CGIs included in the first area.

30. The method of claim 28 wherein identifying the one or more broadcasting stations that respectively serve the one or more cells comprises mapping identified CGI (Cell Global Identity) information with the one or more broadcasting stations.

31. The method of claim 28 wherein determining the registered devices that are positioned within the defined geographic area comprises accessing a database storing location coordinates of the registered devices in the first and second areas, and comparing location coordinates of the registered devices to location coordinates within geographic dimensions of the defined geographic area.

32. The method of claim 28 wherein broadcasting to the devices enabled to communicate with the identified broadcasting stations includes broadcasting to landline phones within the first area.

33. The method of claim 28 wherein broadcasting to the devices enabled to communicate with the identified broadcasting stations includes broadcasting to wireless devices within the first area.

34. A method for broadcasting messages to telecommunications devices within a network, the method comprising:
receiving an indication of a message to be broadcast to multiple telecommunications devices within a first geographic region or regions;
defining at least a second geographic region based on the indication of the message to be broadcast to the multiple telecommunications devices,
wherein the second geographic region approximates the first geographic region or regions;
identifying, within the second geographic region, a first set of transmitter or transceiver devices associated with the network; and
forwarding a selected message to the first set of transmitter or transceiver devices associated with the network, and not forwarding the selected message to a second set of transmitter or transceiver devices outside of the second geographic region,
wherein both the first and second sets of transmitter or transceiver devices provide telecommunications services associated with the network, and
wherein the selected message is substantially concurrently transmitted to the first set of transmitter or transceiver devices within the second geographic region.

35. The method of claim 34 wherein forwarding the selected message to the first set of transmitter or transceiver devices associated with the network includes forwarding the selected message to wireless mobile devices.

36. The method of claim 34 wherein forwarding the selected message to the first set of transmitter or transceiver devices associated with the network includes forwarding the selected message to UMA enabled landlines.

37. The method of claim 34 wherein forwarding the selected message to the first set of transmitter or transceiver devices associated with the network includes forwarding the selected message to RJ-11-type devices.
